(19) United States
(12) Patent Application Publication
(10) Pub. No.: US 2003/0156889 A1
(43) Pub. Date: Aug. 21, 2003

(54) Method for heading a bushing, particularly a bushing forming an elastic articulation and the eleastic articulation and bushing obtained using said method

(76) Inventor: Michel Gautheron, Nevers (FR)

Correspondence Address: SCHIFF HARDIN & WAITE, 6600 SEARS TOWER, 233 S WACKER DR, CHICAGO, IL, 60606-6473, US

(21) Appl. No.: 10/257,828

(22) PCT Filed: Mar. 6, 2002
(86) PCT No.: PCT/EP02/02475

(30) Foreign Application Priority Data
Mar. 6, 2001 (FR) 01/03060

(51) Int. Cl. F16D 3/00

(52) U.S. Cl. 403/24

(57) ABSTRACT

To obtain an elastic joint of which one end is formed by a heading process, with tooth marking in relief, provision of a toothed rivet is provided. These teeth on the rivets are such that they form cavities interspersed with teeth marked on the edge of one end of the joint. It is shown that, by acting in this way, fewer teeth are needed and a correct indexation of the rivet during its successive revolutions is ensured. A lower number of teeth is favorable to a better blockage of the elastic joint against a side plate of a vehicle chassis.

The object of the present invention is a heading process for a socket. This specific type of socket is used to form an elastic joint. Another object of the invention is a socket obtained according to this process, as well as an elastic joint obtained using such as socket. Without implying any limitation, the invention shall be described within the scope of the production of such a socket used to form an elastic joint. The elastic joints involved shall be primarily bearing joints, to be installed as part of a vehicle's suspension. Such elastic joints essentially consist of an internal rigid socket, engaged inside an elastic coupling, for example of rubber. The manufacturing procedure involved in the invention is a heading process in which one end, but preferably both ends of the elastic joint socket, are shaped so as to better comply with its intended use.

From the request made in European patent EP-A-0 524 844, we are acquainted with a process for formation of a machining allowance at the ends of the internal socket in this type of elastic joint, notably after molding, which allows the elastic coupling to adhere to the socket. Moreover, different functions of these elastic joints are described in this document. In a preferred variation of the manner of production of this type of elastic joint in this document, a rivet set is introduced into a hollow end of such a joint's socket, while a reaction is exerted on the other end of this joint. Then the rivet is set in a rolling motion on the rim of this end. During this rolling, the end of the socket becomes deformed and the rivet causes an expansion of this end. Then this end takes on a flared circular shape, whose largest diameter is larger than the greater anterior diameter of the socket. We know that such an enlarging of the diameter at this end favors a better distribution of the fixation stresses of the socket, especially when it is used as a clevis against the side plate of a vehicle chassis.

A refinement of this heading process, also described in the aforementioned document, envisions the formation of teeth on an edge of the end, by spreading out the socket that is to come into contact with the side of this metal side plate. These teeth, which are radially oriented relative to one axis of the socket, are designed to resist slippage of the elastic joint used as a clevis by its internal socket when axial tightening becomes faulty. Thus a salient element constitutes radial grooves in relief, the teeth. These teeth are marked into the metal of the rigid socket by hollow indentations borne on the side of the heading, which is slightly conical. These indentations are made when a short line of support for the rivet rotates in a plane defined by an oblique rivet axis, which causes it to revolve about a geometric axis of the joint.

With heights ranging from 0.3 mm to 1 mm, these radial teeth, like cylindrical salient ribs, tend to impress into the opposing plate during axial tightening of the assembly. Maintenance of rotation, as well as resistance to radial stresses, are considerably improved even with slight axial tightening. We also know, from information in the document quoted above, that the indentations corresponding to these teeth or to the circular ribs of salient elements, and which appear as grooves in the high-strength metal of the rivet, can be obtained by grinding during manufacturing of this rivet. So, they appear in relief on the flat side of the end of the internal rigid socket.

The cited document indicates that the markings of these indentations are made without slippage of the rivet at the time the end of the socket is formed. This occurs, in particular in the example described in this document, when the number of relief teeth is large, for example 24. In fact, during its rolling, the rivet successively imbricates, without slippage, in each of these teeth and, during its manufacture, these teeth extend little by little by penetrating the corresponding grooves in the rivet. The process gets closer to completion, and there is less risk of slippage of the rivet relative to the end of the socket.

Still, tightening the socket onto the side plate cannot impart the properties described above unless this socket's teeth penetrate effectively into the side plate during tightening. Such a penetration is of course not possible unless these teeth are not too close to each other. In fact, if they are too numerous, and therefore too close together, the side plate remains pushed against the crest of all these teeth, without really imbricating between them. The more teeth there are, the weaker the pressure on each tooth will be. So tooth penetration is lost. One solution to improve the efficiency of this tightening consists, then, of either increasing tightening during assembly, or reducing the number of teeth, for example by making a third or a quarter of them.

Unfortunately, in this case we come up against a manufacturing problem. In fact, if the teeth are fewer in number, the distances between them are greater, and the goal here is to optimize the penetration of the side plate into the teeth. Still, the shaping principle with a rivet implies a small support surface for the rivet at the time it is placed on the end of the socket. This small support surface contributes to the exertion of considerable forces on the metal at the end of the socket, whose effect is to shape it. It so happens that under these conditions, the support surface, which in theory is limited to a support line, is, at the time of its formation, situated in the space between two teeth, without the previous or subsequent tooth being imbricated in the rivet. Thus this rivet is subjected to the available effects of slippage, such that the rivet tends to mark the end of the socket, producing a tooth, in a place other than where this rivet had started to mark this tooth during the previous revolution. As a result, as the rivet continues to turn, the teeth, fewer in number, are crushed by the shift in the tool from one turn to the next. Thus none of the teeth can extend. We have seen that because of this, the process does not work unless the number of teeth is kept to a minimum. The problem presented in this case is that, for some applications, the minimum number of teeth is greater than the maximum number of teeth that are useful to optimize a good capture of the socket without excessive tightening.

To solve this problem, it is possible to increase the relief of the cavities made in the support surface of the rivet, in such a way as to mark the teeth more deeply with each pass. In this case, the higher the teeth are, the less a problem there is with obliteration of the work by a previous turn. In this case, forming the end of the socket can be done with a reduced number of teeth. Such a formation of teeth does not occur, however, unless the teeth are high enough. Unfortunately in this case also, greater tightening is necessary in order to ensure the retention of the socket, which the client wishes to avoid.

The result of this situation is that heading, which is the least costly method of producing elastic joints, does not allow us to choose any possible height or number of teeth on the edges of the ends of these joints' sockets. Either there are too many teeth, or the teeth are too high.

The object of the invention is to solve these problems by noting that whether the rivet, in order to be able to retrieve these markings from one revolution to the next, requires numerous indices. These indices do not all need to be in relief; on the contrary, some of them can be grooved. We envision here to provide the slightly-conical surface of the rivet, not only with cavities but also with teeth, in such a way as to produce, on the edge of the end of the socket, respectively, both teeth and cavities. Thus it is possible that the teeth of the rivet, which cause cavities in the edge of the end of the socket, can be high enough to ensure indexation of the rivet during formation of the piece, in spite of their low number. Thus it may be easily understood that during tightening of the socket against a side plate, the side plate can be printed with a small number of teeth presented on this edge, but of course not penetrating, or very little, into the grooves produced in the edge of the socket, thus ensuring good contact between the plate and the edge.

Thus the invention involves a heading process for a socket, in which:

a socket is manufactured,

one end of the socket is subjected to a heading process in order to form teeth in relief on one edge of one end of this socket,

Characterized by the Fact that

during the heading process, cavities are formed on the edge of the end of this socket.

Another object of the invention is a socket, notably a socket for an elastic joint of the type featuring an internal socket captured in an elastic coupling. The edge of one end of the socket features tightening teeth, radially oriented relative to one axis of the socket. These teeth are in relief, characterized by the fact that the edge features cavities interspersed with the teeth in relief.

The invention will be better understood once the following description has been read, and after examination of the accompanying figures. These figures are presented only for information purposes and do not limit the invention in any way. The figures show:

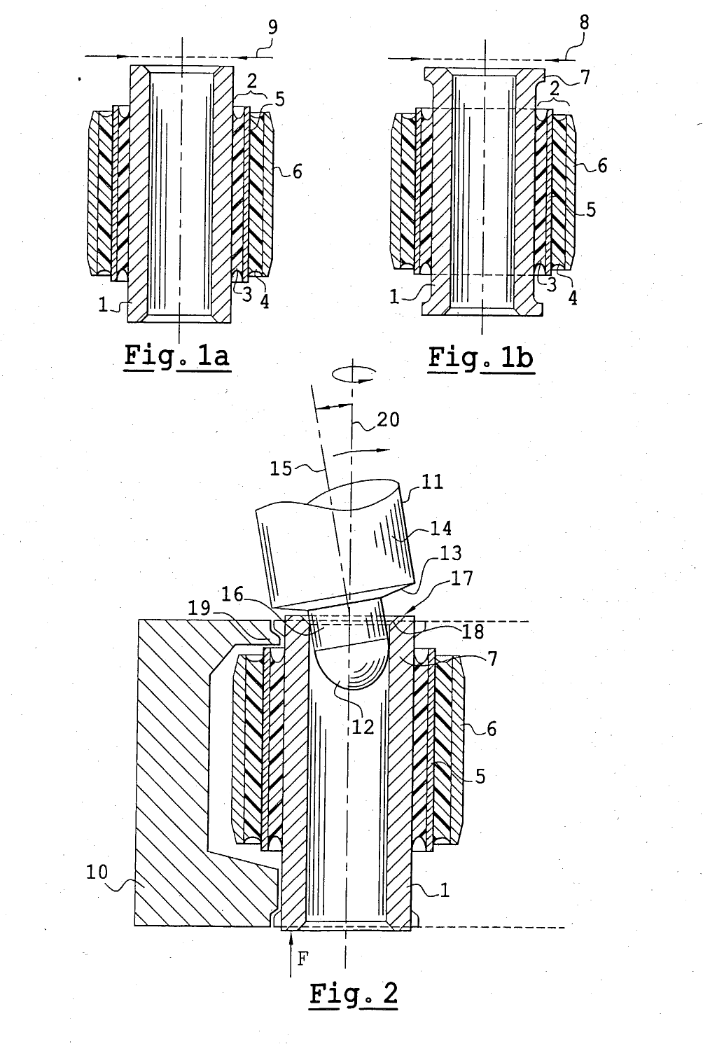

FIGS. 1a and 1b: cross-sectional views of the sockets, and particularly the elastic joints, before and after shaping according to the invention process;

FIG. 2: a schematic representation of a heading machine which can be used in the procedure for the invention;

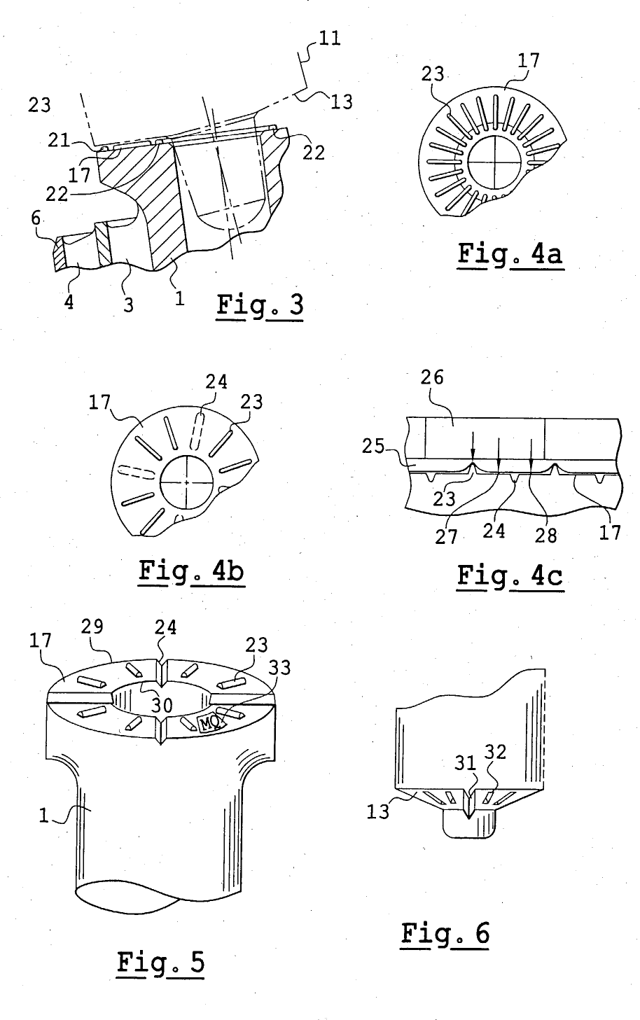

FIG. 3: a detailed view of the heading operation;

FIGS. 4a to 4c: production examples, according, respectively, to the state of the technique and to the invention, of the teeth by the heading process;

FIG. 5: a schematic representation from the perspective of the edge end of the socket of an elastic joint according to the invention;

FIG. 6: perspective representation of a rivet.

FIGS. 1a and 1b show sockets, notably sockets for shaping elastic joints, before and after, respectively, the shaping of the heading according to the invention. In FIG. 1a, a rigid internal socket (1) in engaged in an elastic coupling (2). This engagement can be carried out in advance according to a preferred bonding process described in the quoted document. The elastic coupling (2) can consist of a primary cylindrical enclosure (3) and a secondary cylindrical enclosure (4), separated from each other by an intermediate armature (5) and held at the external periphery by an external armature (6). Socket (1) and armatures (5) and (6) are preferably made of steel. It is known that the interior armature (5) and the exterior armature (6) are subjected to a rolling and/or a shrinking by shock testing machine, that is, a passage into a chock which ensures the reduction of the diameter of the exterior armature (6), in order to compress the material of the elastic coupling.

FIG. 1b takes the same elements by showing that at least one end (7) of the socket (1) was subjected to an expansion, in such a way as the exterior diameter (8) at the place where this expansion is greater than a diameter (9) of the piece before its formation (FIG. 1a). This expansion involves the external side of socket (1). It can also involve the internal side of this socket (1). By proceeding in this way, the fixation qualities of the socket are increased on a support and a material that are not as hard as those in socket (1), typically a side plate of a vehicle chassis. This fixation is carried out by passing a bolt through the socket. This expansion is preferably carried out after molding of the elastic coupling upon the socket to form the elastic joint. Such prior molding is preferable because it is simpler, due to the cylindrical shape of the socket before heading. As a variation, the coupling can be made on the socket, after heading, by molding or by fitting.

FIG. 2 shows the heading procedure known to produce such an expansion. According to this procedure, the socket can be held by a set of two half stamping dies, in half-molds (10) (only the half stamping die on the left side is shown). The heading machine consists of a rivet (11) equipped with a pilot point (12) and a support side (13) that is slightly conical. The support side (13) extends from the pilot point base (12) to the rim (14) of the rivet. The pilot point (12) is engaged inside socket (1). Heading (11) turns on itself, drawn by its axis (15) and, during their rotations, as much on the support side (13) as by the mounting cylinder (16) of pilot point (12) which rolls against extension (7) of socket (1). Support side (13) rolls against edge (17) of this extension (7), whereas mounting cylinder (16) rolls against end (18) of the bore in socket (1). A force F exerted on the other end of socket (1) causes a reaction on the support side (13). A circular support (19) of the half stamping dies (10) can cause a reaction to the force exerted by mounting cylinder (16). The shape of support (19) of the half stamping dies (10) and the shape of the mounting cylinder (16) can be determining factors for the resulting form of expansion of end (7). As a variation, the half stamping dies (10) are not present. In this case, natural expansion occurs. In such a case, the socket is, for example, held on its base by a guide pin and, eventually, by support teeth that are printed by reaction to the lower edge of the socket.

As it rolls, heading (11) turns about an axis (20), which is collinear to the socket axis. The inclination of axis (15) relative to axis (20) is very nearly equal to the inclination of the support side (13) relative to the normal to axis (15), if we want the plane of edge (17) to be perpendicular to axis (20). In practice, rivet (11) is held in place by an internal enclosure of a bearing, either a ball bearing or a needle bearing. The bearing itself is held in place in two ways. Its external enclosure is placed in rotative slippage in a seat. This seat is fixed, with an inclination equal to that of the rivet, to a principal shaft of the rivet, collinear to axis (20), and is drawn by this shaft. In rotation, the internal rolling enclosure is oriented preferably in a set direction, in such a way that the same pitch cone length on side (13) of the rivet are always in the same position on edge (17).

FIG. 3 shows an example of relief production of circular grooves (21) and (22) and the production of teeth (23) on the surface of edge (17). These reliefs result from cavities arranged in conjunction between the support side (13) of rivet (11). Just as the production of circular grooves (21) and (22) is not compromised by the manner in which rivet (11) is formed, so the production of teeth (23) is less possible, unless the number of these teeth is increased. In effect, the origins of the crushing of the teeth, little by little as they are extended, are of three types. First and foremost, the support of side (13) on edge (17) of the socket causes a creep in the socket material, both radially towards the outside (causing expansion) and circularly in the direction of the rotation of the rivet, due to the creation of a material wave in front of the support pitch length of side (13). From one turn to the next, if there are not enough teeth, the rivet cannot index on the teeth, since the creep wave shifts the emerging teeth. Secondly, slippage occurs due to the presence of a necessary slack between pilot point (12) and bore (18). The support circumferences on the socket and on side (13) are different, and lead to such a structural slippage. Thirdly, this last phenomenon is amplified if expansion does not occur on the constant bore diameter (18).

To avoid such crushing, or to overtake this slippage, it is necessary either to increase the number of teeth, or to provide higher teeth (23), in such a way that these teeth can remain permanently engaged in the position of the rivet (11) and of end (7), like a gear pair.

Such a solution, FIG. (4a), leads us to lay out an edge (17), which features a large number of teeth, say, 23; there are 24 in the example. On the opposite side, FIG. (4b) in the invention, we wish to limit the number of teeth. To this end, cavities like (24) are interspersed with teeth like (23), on edge (17). FIG. (4c) shows, in cross-sectional view, when socket (1) is assembled against a side plate (25), a tightening effect caused by a bolt or a screw (26) with or without a support washer. Bolt (26) pushes side (25) against edge (17). It can be observed that teeth (23) enter the side plate (25) while on the side of teeth (23), the side plate (25) can come into contact with this edge (17) using supports (27) and (28). Taking into account the width of cavity (24) and of the stress exerted by bolt (26), it is possible that part of the plate material (25) may creep into cavity (24). Nevertheless, such minimal creep will not weaken the side plate (25). In comparison, it is well understood that if teeth (23) had been too close to each other, supports (27) and (28) could not have been exerted, and pressure at the top of each tooth (23) would have been reduced.

On FIG. (4b), which is only an example, we can observe that the total number of teeth (23) and cavities (24) is thus reduced by half in relation to the number of teeth on FIG. (4a). Moreover, one out of every three teeth is replaced by a cavity, leaving end (17) with 8 teeth and 4 cavities. The distribution of teeth can differ in another way. Either the teeth can be interspersed evenly with the cavities (4 to 4), or the spaces between the teeth could be even, despite the presence of cavities. The solution thus presented represents a good compromise between a small number of teeth (8 instead of 24) taking into consideration a given. hardness of socket material (1).

FIG. (5) shows a perspective view of the preferred method of production of end (17). It features eight teeth like (23), set in groups of two teeth, with these groups separated from each other by cavities like (24). Cavities (24) and teeth (23) are preferably radial and not pierced through, i.e. not abutting the periphery (29) of edge (17). They feature this particularity, notably for reasons of watertightness. Thus their extension is limited in such a way as not to reach either periphery (29) or the interior periphery (30) of edge (17). This particularity is shown here only for the teeth, not for the cavities.

FIG. 6 shows, correspondingly, the appearance of the support side (13) of the rivet's teeth (31) corresponding to cavities (24), and cavities (32) corresponding to teeth (23). As shown above, it is not necessary for the height of teeth (31) to be on the same order as the depth of cavities (32). On the contrary, it may be preferable, for reasons of ease of indexation, that the height of teeth (31) be greater than the depth of cavities (32). Consequently, teeth (23) shall be less high than cavities (24) are deep.* Likewise, the profiles of teeth and cavities are not necessarily similar. These profiles are determined by the function they are to perform. In fact, the purpose of teeth (23) is to print themselves into plate (25). The purpose of cavities (24) is to contribute to a better indexation of the rivet by gear pair effect. The profile of teeth (23) shall thus preferably be the profile described in the quoted document, the profile of cavities (24) in the circular direction may be triangular. In this example, an angle at the top of this cavity profile is shallower than the angle at the top of teeth (23). *Literal translation appears to be contradictory.

Moreover, due to the quality of indexation achieved in this way, it is possible to provide the rivet with cavities or protuberances which are likely to produce an inscription, a mark (33), in the place of or in addition to teeth (23), on edge (17) or on the end (18) of the bore of the socket.

Finally, we shall note here that a socket of this type with few teeth and cavities is nevertheless well adapted to an indexation.

### SUMMARY

### Heading Procedure for a Socket, Notably for a Socket Forming an Elastic Joint, and a Socket and Elastic Joint Obtained Using this Process

To obtain an elastic joint (1) of which one end is formed by a heading process, with tooth marking (23) in relief, provision of a toothed rivet is proposed. These teeth on the rivets are such that they form cavities (24) interspersed with teeth marked on the edge (17) of one end of the joint. It is shown that, by acting in this way, we may, at the same time, produce fewer teeth and ensure a correct indexation of the rivet during its successive revolutions. A lower number of teeth is favorable to a better blockage of the elastic joint against a side plate of a vehicle chassis.

FIG. 5.

1- heading process for a socket, in which
a socket (1) is produced,
one end (7) of the socket is subjected to a heading process (11) in order to form teeth (23) in relief on the edge (17) of one end of this socket.
These teeth are characterized by the fact that:
in the course of this heading process, cavities (24) are made on the edge of the end of this socket.

2- Process according to claim 1, characterized by the fact that
during the heading process, an enlargement (8, 9) is formed on one end of the socket, whose end features these teeth.

3- Process according to one of claims 1 to 2, characterized by the fact that
these cavities are used to create a fine marking (33).**

4- Process according to one of claims 1 to 3, characterized by the fact that
an elastic coupling is made on the socket, before the heading, in order to form an elastic joint.

5- Socket (1) featuring an edge (17) on the end of the socket, which has tightening teeth that are radially oriented relative to an axis of the socket, these teeth being in relief, characterized by the fact that the end features cavities (24) interspersed with teeth in relief.

6- Socket according to claim 5, characterized by the fact that it has an expansion at one end whose face is provided with these teeth.

7- Socket according to one of claims 5 to 6, characterized by the fact that the expansion and/or the teeth in relief and the cavities are obtained with a rivet.

8- Socket according to one of claims 5 to 7, characterized by the fact that these cavities have a radial orientation.

9- Socket according to one of claims 5 to 8, characterized by the fact that the teeth and/or the cavities are not pierced through (29, 30).

10- Socket according to one of claims 5 to 9, characterized by the fact that it features an elastic coupling, engaged on the socket and featuring a cylindrical intermediate armature (5) and two elastic enclosures (3, 4) engaged onto one side and on another of this intermediate armature.

11- Socket according to one of claims 5 to 10, characterized by the fact that the end features eight teeth in relief and four grooved teeth.

12- Socket according to one of claims 5 to 11, characterized by the fact that the cavities feature, in the circular direction, a triangular profile with a top angle that is shallower than the top angle of the profile of the teeth.

13- Socket according to one of claims 5 to 12, characterized by the fact that the end of the socket features a marking indication.
